(19) United States
(12) Patent Application Publication
(10) Pub. No.: US 2018/0007884 A1
(43) Pub. Date: Jan. 11, 2018

(54) Storage Container with Removable Storage Inserts for Storing Fishing Weights and Fishing Hooks

(71) Applicant: Mafia Outdoors, LLC, Russellville, AR (US)

(72) Inventors: J. Barton Langley, Russellville, AR (US); Jeremy S. Starks, Scott Depot, WV (US)

(21) Appl. No.: 15/644,516

(22) Filed: Jul. 7, 2017

Related U.S. Application Data
(60) Provisional application No. 62/360,202, filed on Jul. 8, 2016.

(51) Int. Cl. A01K 97/06; B65D 43/22; B65D 43/16; B65D 43/12; B65D 25/10; B65D 81/107; B65D 25/04

(52) U.S. Cl. CPC A01K 97/06; B65D 81/107; B65D 43/22; B65D 25/04; B65D 43/12; B65D 25/108; B65D 43/163

(57) ABSTRACT

A durable and waterproof fishing product storage container having a plurality of walls that are joined to form an internal compartment. The internal compartment is separated into smaller sub-compartments by a plurality of lengthwise and widthwise dividers. Storage inserts containing foam material used to hold and store fishing products, including weights and hooks, may be inserted into the storage compartment of the container. A lid is attached to each of the storage inserts so that the items stored in the foam material may be properly secured inside the inserts.

### CROSS-REFERENCE TO RELATED APPLICATIONS

This application claims the benefit of U.S. Provisional Patent Application No. 62/360,202, entitled “Fishing Tackle Box with Removable Storage Boxes” and filed on Jul. 8, 2016. The complete disclosure of said provisional application is hereby incorporated by reference.

### STATEMENT REGARDING FEDERALLY SPONSORED RESEARCH OR DEVELOPMENT

Not applicable

### BACKGROUND OF THE INVENTION

Recreational fishing is an activity enjoyed by tens of millions of people each year. In fact, some reports estimate that nearly forty-six million Americans participate in fishing activities in any given year. An average fishing participant is estimated to fish approximately 19.4 outings per year, with total combined fishing outings estimated at approximately 893 million times per year. While many of these fishermen cite the rush of catching a fish, the joys of the sights and sound of nature, and spending time with family as the best things about fishing, many fishermen say that one of the worst things about fishing is not having the right equipment.

While many people unfamiliar with fishing know the importance of fishing lures and baits, which are used to attract fish to the hook, those avid fisherman also know the importance of using weights in addition to their hooks and lures. Fishing weights are used for a variety of purposes, including to increase the rate of sinking of the lure and hook, to help anchor the lure and hook at a depth, and to help the fisherman in casting the lure and hook at a distance. Given the different purposes and different situations in which weights may be used, a variety of weight types, sizes, shapes, and styles exist. A fisherman therefore is often required to carry a number of various weights on his or her fishing trip. For this reason, a storage box is a vital piece of equipment for anyone who engages in fishing activities.

Traditionally fishing weights have been stored in an open compartment in a regular plastic tackle box. This often means storing a number of weights in a single compartment. When weights are stored this way they constantly are beating and rubbing against one another. This rubbing of the weights ultimately causes the expensive finish to wear off fairly quick. This not only damages the appearance of the weights but also generally leads to damage of the fishing lines on which the weights are used because tungsten weights are made from an extremely hard material that, when coming in contact with fishing line, can fray the line at the point of contact. The painted finish on these weights serves as a buffer to protect the fishing line. Similarly, the storage of fishing hooks has also traditionally been in an open compartment. Just like with weights, this leads to hooks rubbing against one another. Hooks rubbing against one another damages the hook point, which typically requires the hooks to be sharpened. An improve tackle box or storage container that is sufficient for storing weights and hooks is needed to overcome the problems associated with traditional tackle boxes.

### BRIEF DESCRIPTION OF THE DRAWINGS

FIG. 1 is a perspective view of one embodiment of the storage container of the present invention with six removable storage inserts and a number of smaller individual storage compartments.

FIG. 2 is a top view of one embodiment of the storage container of the present invention with six removable storage inserts with lids open and a number of smaller individual storage compartments.

FIG. 3 is a top view of one embodiment of the storage container of the present invention showing one of the removable storage insets and a number of smaller individual storage compartments.

FIG. 4 is a top view of one embodiment of the storage container of the present invention in the closed position.

FIG. 5A is a perspective view of one embodiment of a storage insert of the present invention showing a storage insert with slits for storage of hooks.

FIG. 5B is a perspective view of one embodiment of a storage insert of the present invention showing a storage insert with holes for storage of weights.

FIG. 6A is a perspective view of one embodiment of a storage insert of the present invention showing a storage insert with slits for storage of hooks and with the lid of the storage insert being opened.

FIG. 6B is a perspective view of one embodiment of a storage insert of the present invention showing a storage insert with holes for storage of weights and with the lid of the storage insert being opened.

FIG. 7A is a top view of one embodiment of the storage container of the present invention showing individual compartments within the storage container and showing the position of a storage insert configured to be inserted into the storage container.

FIG. 7B is a side view of one embodiment of the compartment section of the storage container of the present invention.

FIG. 8A is a top view of one embodiment of a storage insert of the present invention.

FIG. 8B is a side view of one embodiment of a storage insert of the present invention.

FIG. 8C is a perspective view of one embodiment of a storage insert of the present invention.

FIG. 8D is end view of one embodiment of a storage insert of the present invention.

### DETAILED DESCRIPTION OF THE INVENTION

The present invention is directed to fishing products and more particularly to a durable storage container for holding a quantity of fishing products including fishing weights and fishing hooks. While the preferred embodiment of the present invention is configured to store weights and hooks, it is understood that any variety of fishing products may be used with the storage container described herein. The present invention completely protects the weights and hooks from any damage. The weights are kept secure by using a combination of an ABS case and closed cell foam, as described more fully below. ABS, or acrylonitrile-butadiene-styrene, is a light-weight and durable thermoplastic material. While any other plastic, metal, or other durable material may be used, it is recognized that the benefits of the present invention are best realized if the container is made of an ABS material.

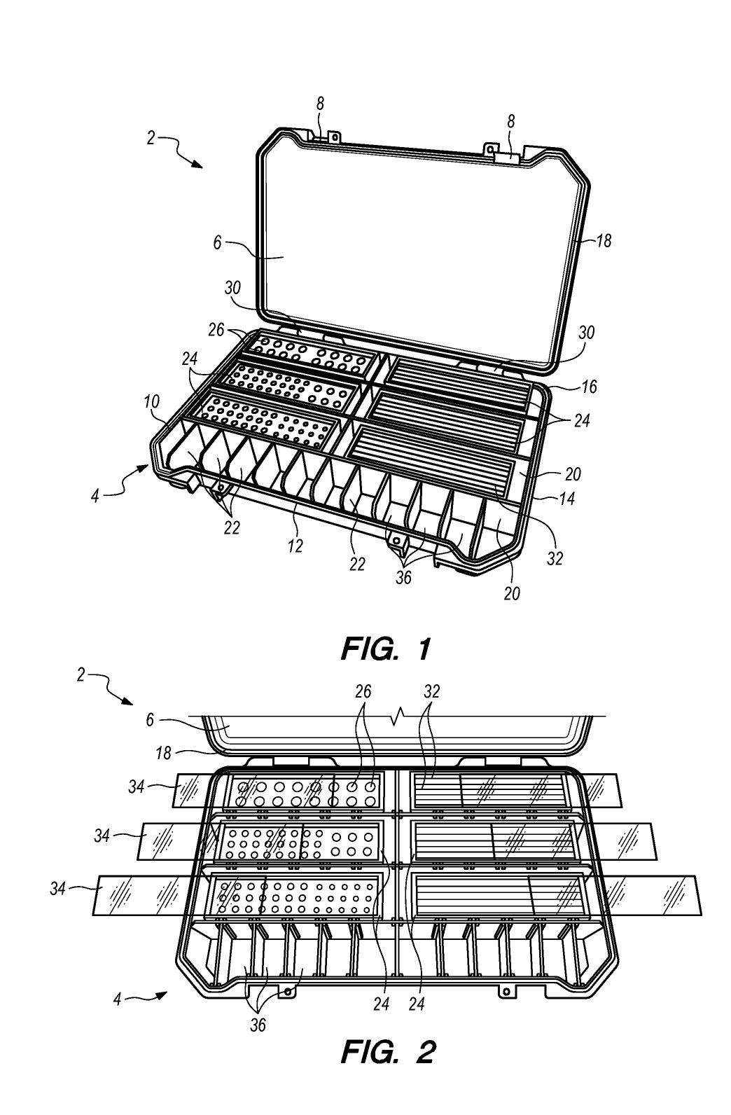

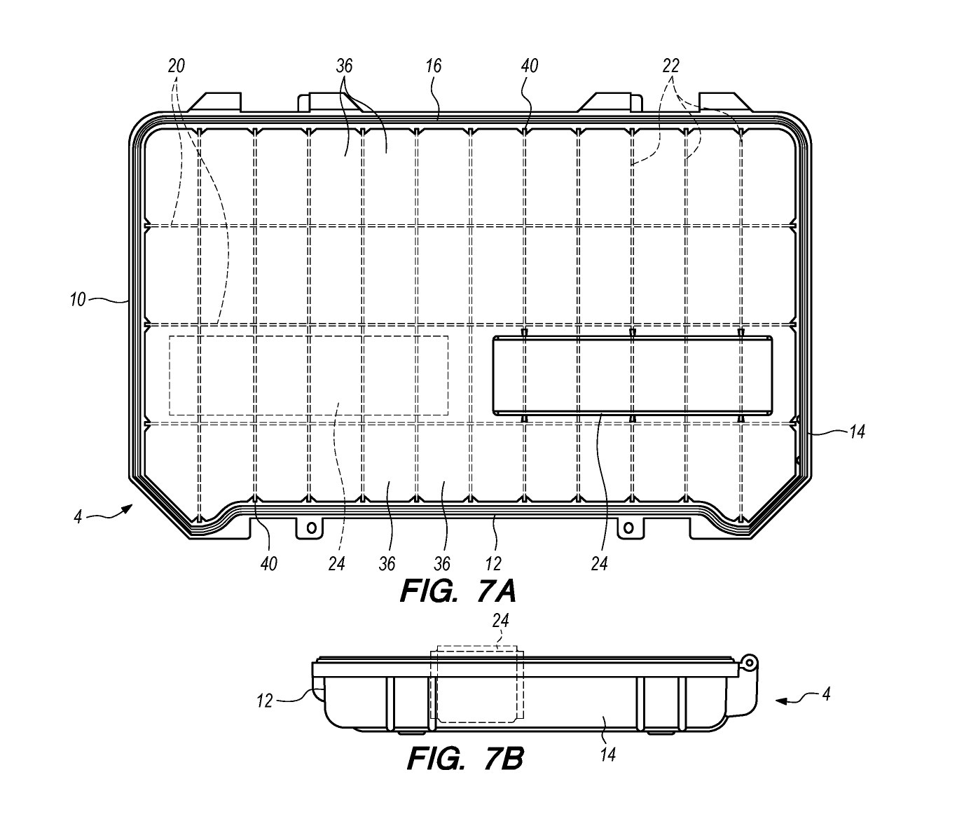

With reference to FIGS. 1-8D, the preferred embodiment of the fishing tackle container with removable storage inserts of the present invention may be described. Generally, the storage container 2 is made up of a bottom compartment section 4 and a lid 6. The compartment section 4 is generally made up of outer walls (a left side wall 10, front side wall 12, right side wall 14, and back side wall 16) and a bottom surface 28 connecting the bottom of the outer walls 10, 12, 14, 16 to form an internal compartment have a depth corresponding to the height of the outer walls 10, 12, 14, 16. The internal compartment has a number of internal walls, a subset of which run parallel to the front and back outer walls (lengthwise walls 20) and a subset of which run parallel to the left and right outer walls (widthwise walls 22), as shown in FIG. 7A. These internal walls 20, 22 intersect at various points to create a number of smaller, individual storage areas 36 inside the main internal compartment. In one embodiment, the front side wall 12 is connected to the left side wall 10 and right side wall 14 with chamfered corners. These chamfered corners not only add to the aesthetic appeal of the container 2, but also makes the container 2 stronger and more durable.

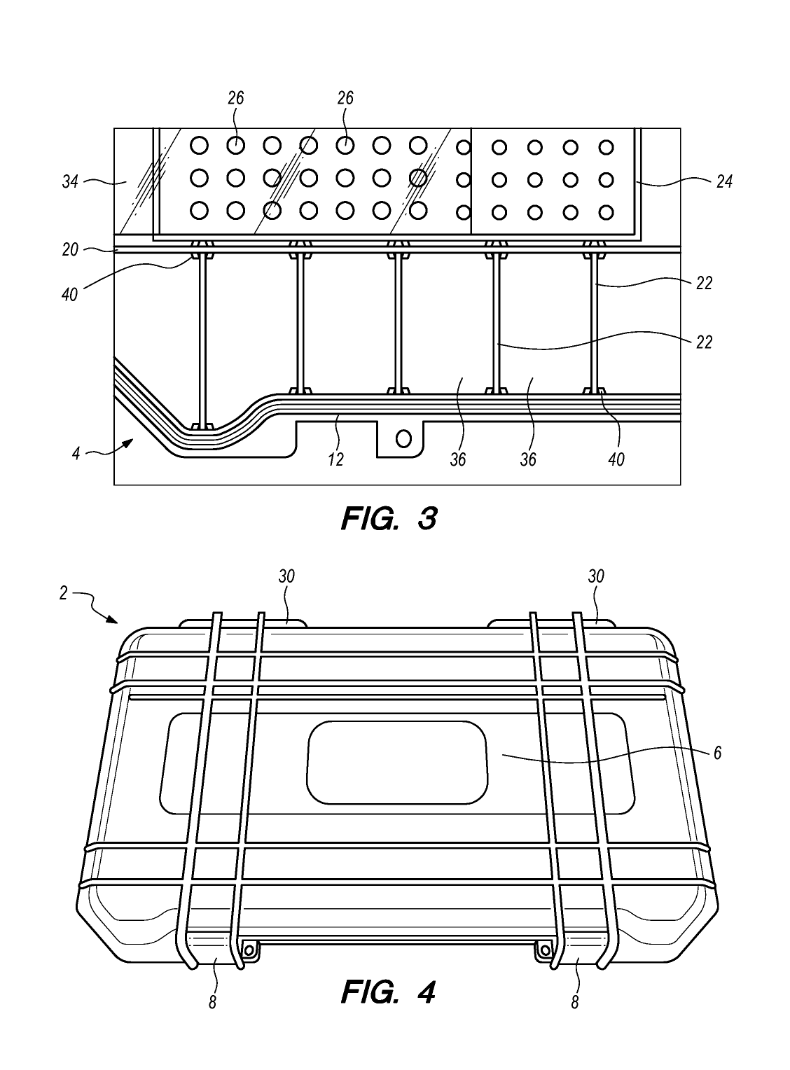

The internal walls 20, 22 preferably are the same height as the outer walls 10, 12, 14, 16 such that the individual internal compartments 36 have substantially the same depth as the main internal compartment. One of the subset of internal walls (for example, the widthwise internal walls 22 running parallel to the left side outer wall 10 and the right side outer wall 14) are capable of being inserted or removed from the storage container 2 to create individual storage compartments 36 of varying sizes. As shown in FIG. 3, in order to allow the internal walls to be secured to and removed from the compartment section 4 of the container 2, the internal walls may, for example, contain notches and grooves to facilitate the removable sliding of the internal walls. For example, in one embodiment, the lengthwise internal walls 20 may contain a number notches spaced apart down the length of the wall 20. These notches are designed to receive the removable widthwise walls 22. Furthermore, the widthwise walls 22 may contain grooves on their ends such that are capable of being slid in and out of the notches on the lengthwise walls 20. The inside surface of the outer lengthwise walls (i.e. the front wall 12 and the back wall 16) may also have notches for receiving the widthwise internal walls 22. These notches (and those on the lengthwise internal walls 20) are designed such that the grooved ends of the widthwise walls 22 slide into the notches, which in turn hold the widthwise walls 22 in a vertical position, thus creating the internal compartments.

In order to modify the number, size, and spacing of the individual internal compartments, the container is designed such that any number of internal walls may be removed from these notches. For example, a widthwise wall may be placed in every notch, thus creating a number of substantially equal sized individual compartments. Alternatively, half of the container may have widthwise walls in every notch and another half of the container may have widthwise walls in every third notch. In such a scenario, half of the container would have smaller individual compartments while the other half would have larger individual compartments. The size of the individual compartments can be modified to fit any fishing need by removing or adding the internal walls in any combination. Furthermore, while the example given herein refers to the lengthwise walls 20 having notches and the widthwise walls 22 being removable, it is understood that in one embodiment the lengthwise walls 20 are the removable walls and the widthwise walls 22 are stationary and have notches. In such a case, the widthwise outer walls (i.e. the side walls 10 and 14) may also have notches for receiving the lengthwise internal walls 20, as shown in FIG. 7A.

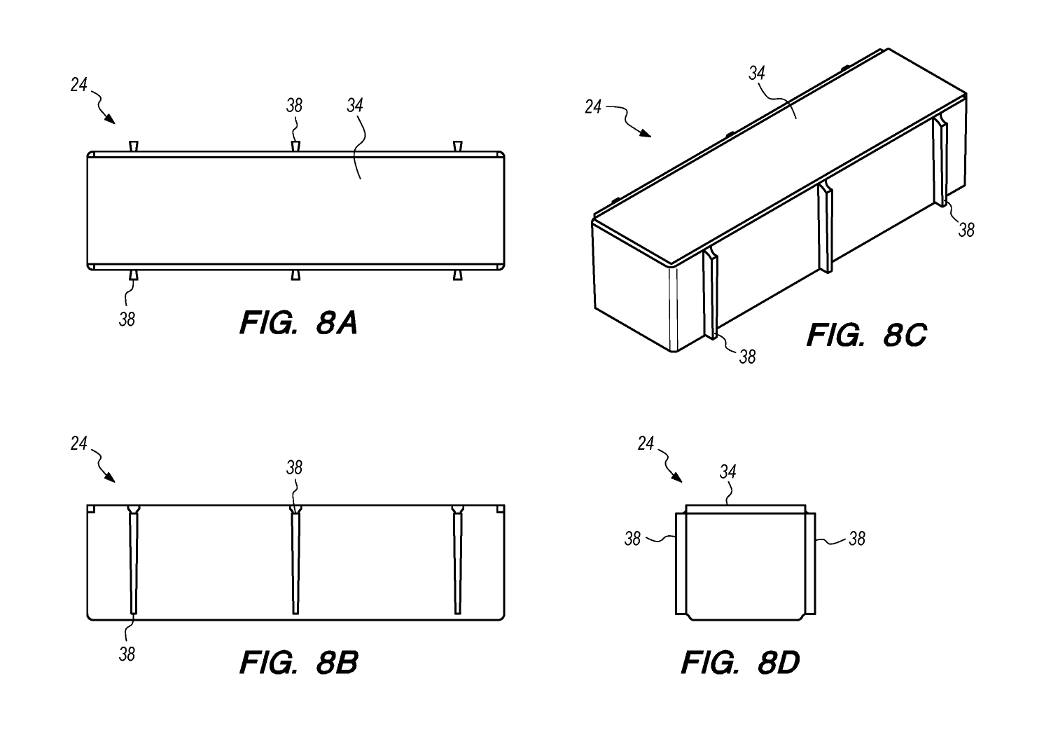

In the preferred embodiment, a number of the widthwise internal walls 22 are removed to create storage areas large enough to receive a number of storage inserts 24 (described below). For example, FIGS. 1-2 show a number of widthwise internal walls 22 removed from the compartment such that a number of storage inserts 24 can be fit into the compartment 4. In such an embodiment, the storage inserts 24 preferably have grooves 38 on the walls of the storage insert 24, as shown in FIGS. 8A-8D. These grooves 38 are intended to slide in the notches 40 on the internal walls. Thus, these grooves 38 serve to secure the storage inserts 24 to the stationary internal walls of the compartment 4 such that the storage inserts 24 remain in the same position while inside the container 2. Alternatively, the storage inserts 24 may be manufactured integral to the storage container 2, thus leaving a portion of the storage container 2 with smaller individual compartments 36 for storing various fishing products (as shown, for example, in FIG. 3), in which case widthwise internal walls 22 may only be added or removed from that portion of the storage container 2. As shown in FIGS. 1-2, in the preferred embodiment, the internal storage compartment of the storage container 2 is configured such that it is capable of holding six storage inserts 24, with three of the inserts preferably for weights (each of the three inserts having a number of different size holes 26) and three inserts for storing hooks (each of the three inserts having a number of slits 32). However, any combination of different storage inserts 24 (for example, all containing holes 26 or all containing slits 32) may be used depending on the needs of the container's owner.

As noted above, a number of storage inserts 24 are used to store the weights and hooks in the storage container 2 of the present invention. These storage inserts 24 may be manufactured separately (and therefore capable of being added and removed from the storage container 2) or may be manufactured integral to the storage container 2. These storage inserts 24 use a foam or other soft material that is specifically designed for storage of weights and hooks such that these types of fishing products will not get damaged. The foam material 24 is preferably cased in a housing made of durable material so that the entire insert 24 can be easily removed from the storage container 2, thus allowing the storage container 2 to be customized according to the present needs of the fisherman. The storage inserts 24 are preferably rectangular in shape such that the inserts 24 can conveniently fit inside the storage compartment 4 of the storage container 2. In the preferred embodiment, each of the storage inserts 24 has its own cover 34, as shown in FIGS. 6A-6B. Each of these covers 34 is preferably made of clear plastic and covers the top opening portion of a single storage insert 24. This allows the cover 34 to keep the fishing products in place in the insert 24 while also allowing the user to see the contents of the insert 24. In the preferred embodiment, the cover 34 slides longitudinally along the top of the storage insert 24, allowing the user to slide the cover 34 along the top edge of the storage insert to open and close the cover 34. In one embodiment, the plastic housing of the storage insert 24 has a groove for slidably receiving the cover 34. Because each storage insert 24 has its own cover 34, the user may also remove a storage insert 24 entirely from the container 2 without losing any contents of that storage insert 24. In alternative embodiments, the cover 34 may attach to the storage insert 24 via hinges or other means. In addition, because the cover 34 is separate from the insert 24, the cover 34 can be removed from the insert 24 while the insert is inside the compartment, as shown in FIG. 2. This allows the user to retrieve items from the foam material of the insert 24 without requiring the user to remove the insert 24 from the compartment.

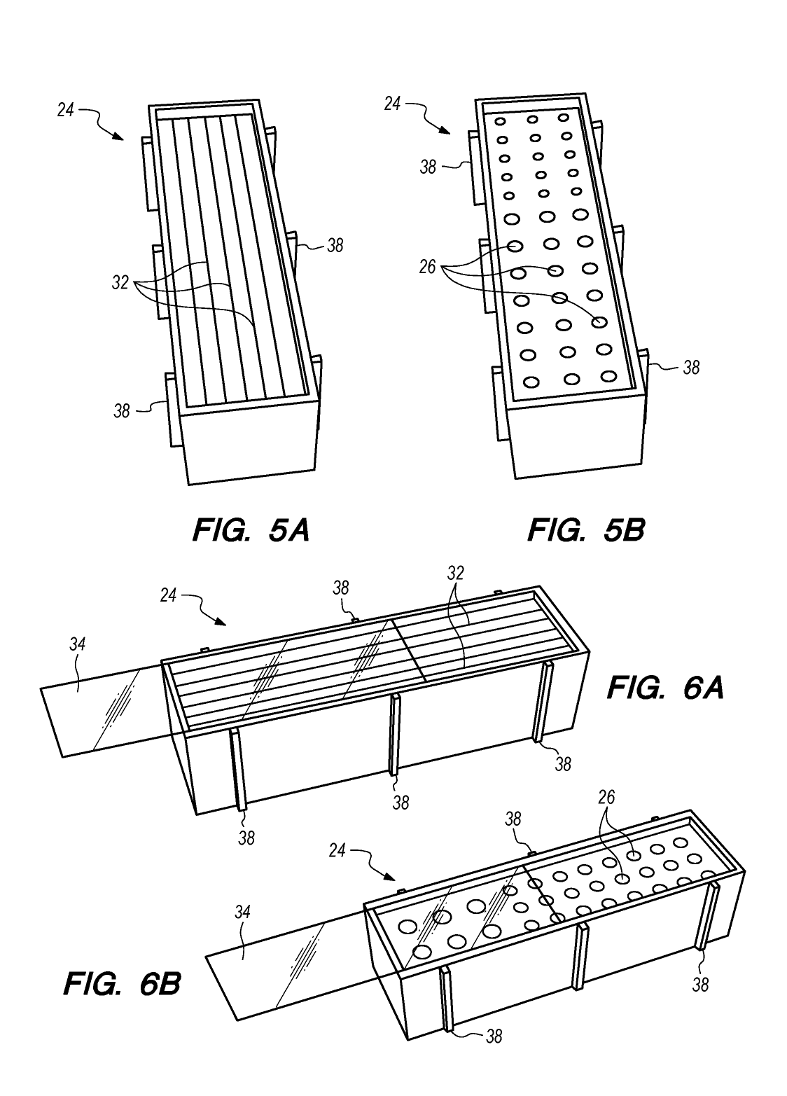

As shown in FIGS. 5A-5B, each storage insert 24 has a number of holes 26 of specific size and depth or slits 32 molded into the foam material. In one embodiment, a single insert 24 may have both holes 26 and slits 32, while in other embodiments, a single insert 24 exclusively has holes 26 or slits 32 but not both. The holes 26 are preferably evenly spaced in rows on the foam material of the insert 24 and are configured to receive fishing weights. The slits 32 preferably extend across the foam material for receiving a hook. The holes 26 or slits 32 are designed to hold the weights or hooks, and the depth of each hole 26 or slit 32 is important in relation to each size weight. If the weight hole 26 is too deep for that particular size weight, then the weight buries deeper and is hard to remove. For this reason, the storage inserts 24 preferably come in four configurations: ⅛-¼ oz., 5/16-¾ oz., 1-1.5 oz., and a hook holding foam, which cover the most popular size weights and hooks. It is understood, however, that the characteristics of the storage inserts 24 may be modified to fit the needs associated with varying fishing products and equipment depending on their size and shape.

The lid 6 acts as the top surface of the storage container 2, as shown in FIG. 1, which allows the storage container 2 to be transported without losing the contents of the compartment section 4. The lid 6 has a sealing O-ring 18 that is used to create a water-tight seal when the lid 6 is closed. This creates a waterproof storage container 2 when the lid 6 is closed, which ultimately serves to keep the contents of the storage container 2 free of rust. One embodiment of the storage container 2 has a lip on the upper portion outer walls 10, 12, 14, 16 of the compartment section 4. The lid 6 and sealing ring 18 on the inside of the outer edges of the lid 6 are configured to fit securely around this lip which further facilitates waterproofing of the container 2.

The storage container 2 is preferably created from an acrylonitrile butadiene styrene (ABS) material that is extremely durable and crush resistant. This not only provides a strong and durable container, but also allows the container to float. In the preferred embodiment, the lid 6 is hingedly connected to the storage compartment 4. Specifically, the lid 6 is hingedly attached using a set of hinges 30 that connect the lid 6 to the back wall 16 of the storage compartment 4. This allows the lid 6 to be opened and closed while remaining connected to the storage compartment section 4 of the storage container 2. A set of latches 8 is attached to the lid 6 so that the lid 6 may be secured in the closed position by connecting the latches 8 to their counterparts on the front wall 12 of the storage compartment 4.

The present invention has been described with reference to certain preferred and alternative embodiments that are intended to be exemplary only and not limiting to the full scope of the present invention.

We claim:

1. A storage container for fishing products comprising:
a. a compartment comprising a front wall, a back wall, a first side wall, a second side wall, and a bottom surface;
b. a lid attached to the compartment;
c. a plurality of lengthwise dividers extending between the first side wall and the second side wall;
d. a plurality of widthwise dividers extending between the front wall and the back wall; and
e. a plurality of storage inserts configured to receive a fishing weight or a fishing hook.

2. The storage container of claim 1, wherein each of the plurality of storage inserts comprises a slidable lid.

3. The storage container of claim 1, wherein the plurality of widthwise dividers are slidably removable from the compartment.

4. The storage container of claim 1, wherein the plurality of lengthwise dividers are slidably removable from the compartment.

5. The storage container of claim 1, wherein the storage insert comprises:
a. a housing;
b. a foam piece positioned in the housing; and
c. a plurality of openings in the foam.

6. The storage insert of claim 5, wherein the plurality of openings comprises holes.

7. The storage insert of claim 5, wherein the plurality of openings comprises slits.

8. The storage container of claim 1, wherein each of said plurality of lengthwise dividers comprises a notch.

9. The storage container of claim 1, wherein each of said plurality of widthwise dividers comprises a groove.
